(19) United States
(12) Patent Application Publication
(10) Pub. No.: US 2024/0318782 A1
(43) Pub. Date: Sep. 26, 2024

(54) PRESSURE CONTAINER AND MANUFACTURING METHOD THEREFOR

(71) Applicant: TOYODA GOSEI CO., LTD., Kiyosu-shi (JP)

(72) Inventors: Kosuke KUSABA, Kiyosu-shi (JP); Kotaro SUZUKI, Kiyosu-shi (JP)

(21) Appl. No.: 18/598,079

(22) Filed: Mar. 7, 2024

(30) Foreign Application Priority Data
Mar. 22, 2023 (JP) 2023-046084

(51) Int. Cl. F17C 1/02

(52) U.S. Cl. CPC F17C 1/02; F17C 2203/0619; F17C 2203/0663; F17C 2223/0123; F17C 2260/011

(57) ABSTRACT

An object is to sufficiently ensure gas barrier properties while achieving efficient gas filling without a liner. A pressure container includes: a storage member extending in an axial direction and capable of occluding and releasing gas; a cap placed at an end portion in the axial direction of the storage member; a reinforcing layer covering outer circumferential surfaces of the storage member and the cap; and a gas barrier layer interposed between the outer circumferential surfaces and an inner circumferential surface of the reinforcing layer, formed in a film shape, and having gas barrier properties and heat-shrinkable properties.

### TECHNICAL FIELD

The present invention relates to a pressure container capable of being filled with gas at a higher pressure, and a manufacturing method therefor.

### BACKGROUND ART

Hitherto, a pressure container that is mounted on a vehicle or the like and capable of being filled with gas such as hydrogen gas and natural gas at a high pressure has been known (e.g., JP6000618 (B)). The pressure container described in JP6000618 (B) includes a container body as a liner made of a resin, caps which are placed on both axial end sides of the container body, and a reinforcing layer which covers the outer circumferential surfaces of the container body and the caps. The reinforcing layer improves the pressure resistance of the pressure container.

Liner-less pressure containers made of a resin are beginning to be considered for cost reduction and weight reduction. Meanwhile, for efficiently filling a pressure container with gas, pressure containers using storage members capable of occluding and releasing gas are also being developed.

### SUMMARY OF INVENTION

### Technical Problem

However, if a pressure container has a liner-less structure using a storage member as described above, the cost and the weight of the pressure container are reduced while efficient gas filling is achieved, but the structure as it is does not have a layer to shield the gas stored in the storage member, so that the gas is released through gaps at the reinforcing layer and gas barrier properties are not ensured.

The present invention has been made in view of such circumstances, and an object of the present invention is to provide a pressure container capable of sufficiently ensuring gas barrier properties while achieving efficient gas filling without a liner.

### Solution to Problem

An aspect of the present invention is directed to a pressure container including: a storage member extending in an axial direction and capable of occluding and releasing gas; a cap placed at an end portion in the axial direction of the storage member; a reinforcing layer covering outer circumferential surfaces of the storage member and the cap; and a gas barrier layer interposed between the outer circumferential surfaces an and inner circumferential surface of the reinforcing layer, formed in a film shape, and having gas barrier properties and heat-shrinkable properties.

With this configuration, gas barrier properties are sufficiently ensured while efficient gas filling is achieved without a liner.

### BRIEF DESCRIPTION OF DRAWINGS

FIG. 1 is a perspective view of a pressure container according to an embodiment of the present invention;

FIG. 2 is a cross-sectional view of the pressure container of the embodiment;

FIG. 3 is an exploded perspective view of the pressure container of the embodiment;

FIG. 4 is an enlarged cross-sectional view of a main part of the pressure container of the embodiment; and

FIG. 5 is a diagram illustrating an example of a procedure for manufacturing the pressure container of the embodiment.

### DESCRIPTION OF EMBODIMENTS

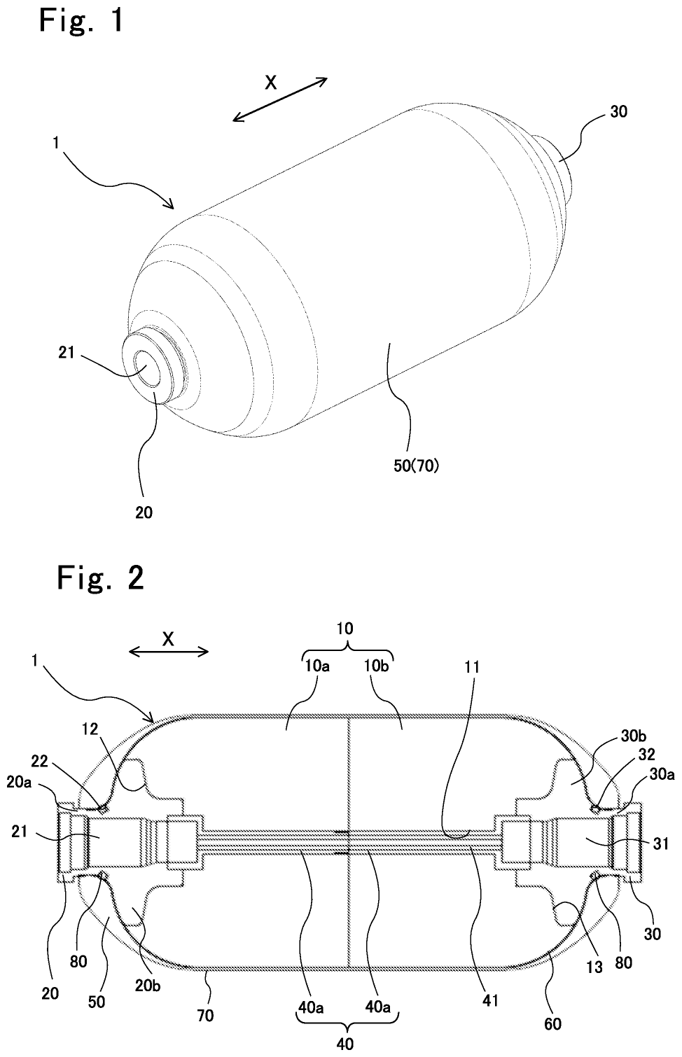

Hereinafter, a specific embodiment of the pressure container according to the present invention and a manufacturing method therefor will be described with reference to FIG. 1 to FIG. 5.

A pressure container 1 according to the embodiment is a container for storing gas and releasing the stored gas. The pressure container 1 is installed in a vehicle that runs, for example, with the gas as fuel, or the like. The gas stored by the pressure container 1 may be any type of gas, but is suitable to be fuel gas such as hydrogen gas or natural gas. In addition, the pressure of the gas stored by the pressure container 1 may be any pressure, but may be a high pressure (e.g., 100 MPa). That is, the pressure container 1 may be a pressure-resistant container.

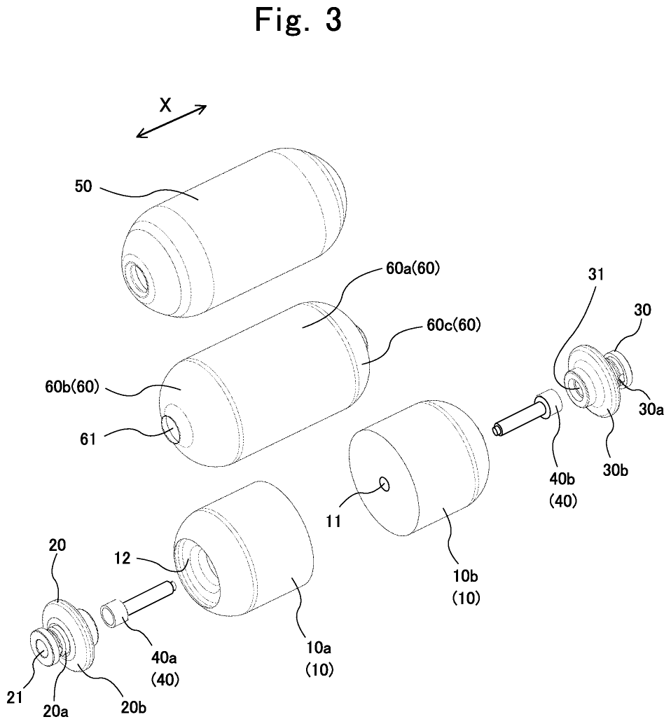

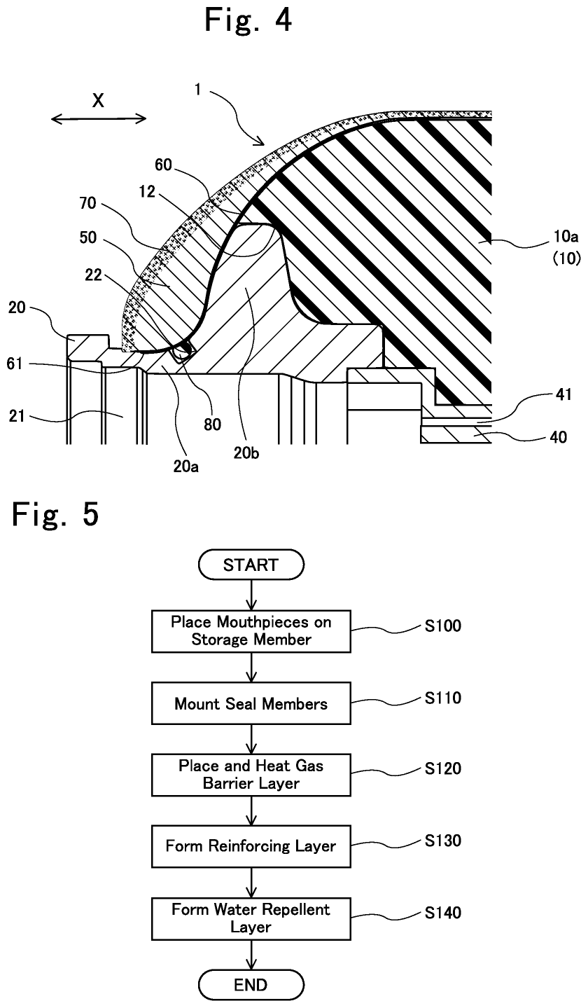

The pressure container 1 is formed in a columnar shape (specifically, a circular column shape). As shown in FIG. 1, FIG. 2, FIG. 3, and FIG. 4, the pressure container 1 includes a storage member 10, caps 20 and 30, a shaft 40, a reinforcing layer 50, a gas barrier layer 60, and a water repellent layer 70.

The storage member 10 is a member for storing gas. The storage member 10 is capable of both occluding and releasing gas. The storage member 10 is formed in a columnar shape (specifically, a circular column shape) and extends in an axial direction X. The storage member 10 is formed such that a diameter thereof is substantially uniform at a center portion thereof in the axial direction X and decreases at both end portions thereof in the axial direction X from the center side in the axial direction X to the end sides in the axial direction X. Hereafter, the portion at which the diameter is substantially uniform in the storage member 10 is referred to as body portion, and the portions at which the diameter decreases in the storage member 10 are referred to as dome portions.

The storage member 10 has a capacity that allows a predetermined amount of gas to be stored therein. The storage member 10 may be provided with flow paths through which the gas flows, for example, in order to make the gas concentration uniform over the entire storage member 10. The storage member 10 is formed of a material according to the type of the gas to be stored. The material of the storage member 10 is, for example, a porous carbon material such as carbon nanotubes, a porous metal complex (i.e., MOF), zeolite, a hydrogen storage alloy, a metal hydride, or the like.

The storage member 10 may be formed, for example, in the form of consolidated powder such as primary particles or secondary particles, that is, in the form of pellets. The storage member 10 in the form of pellets ensures a large contact area of the storage member 10 with the gas, thereby improving gas occlusion and release performance. In this case, the storage member 10 may be formed by crosslinking powder of the storage member material by a crosslinking agent or binding the powder of the storage member material by a binder. The crosslinking agent or binder is formed of, for example, a silicone-based, epoxy-based, or amine-based material.

The storage member 10 may have varying performance in accordance with the position in the axial direction X, and may be, for example, configured to have higher breakage resistance at each end portion thereof in the axial direction X than at a center portion thereof in the axial direction X. This breakage resistance is an index indicating the difficulty of powdering of the storage member 10 obtained by consolidating powder. The breakage resistance is rephrased as strength, rigidity, wear resistance, viscosity, elasticity, etc.

The storage member 10 may be, for example, housed in each housing space of a housing member formed in a honeycomb shape, and held so as to be surrounded by compartment walls of the housing member. In this case, the housing member in which the storage member 10 is housed may have a rotation preventing structure described later, as a part of the storage member 10. In the case where the storage member 10 is housed in the housing member, the compartment walls of the housing member may be formed of a thermally conductive material and function as a heat exchanger. Like the shaft 40, this thermally conductive material is a material whose thermal conductivity at ordinary temperature (e.g., 25° C.) is higher than the thermal conductivity of air, and specifically may be a metal, an alloy, ceramics, or the like represented by stainless steel, aluminum, alumina, silicon carbide, etc.

Furthermore, the storage member 10 is composed of a plurality of separate parts. Specifically, as shown in FIG. 2 and FIG. 3, the storage member 10 is composed of two storage member separate parts 10a and 10b which are separated at the center portion in the axial direction X. The storage member separate parts 10a and 10b oppose or are in contact with each other in the axial direction X at the center portion in the axial direction X. Each of the storage member separate parts 10a and 10b includes a part of the body portion and a part of the dome portion.

The storage member 10 includes fitting portions 12 and 13. The fitting portion 12 is a portion to which the cap 20 is fitted. The fitting portion 12 is provided at one end portion in the axial direction X of the storage member separate part 10a, and is exposed at one end in the axial direction X of the storage member 10. The fitting portion 13 is a portion to which the cap 30 is fitted. The fitting portion 13 is provided at another end portion in the axial direction X of the storage member separate part 10b, and is exposed at another end in the axial direction X of the storage member 10. Each of the fitting portions 12 and 13 has an opening formed, for example, in a circular shape. The cap 20 is fitted to the fitting portion 12, and the cap 30 is fitted to the fitting portion 13.

The caps 20 and 30 are each a member that allows the gas to enter and exit between the inside of the pressure container 1 (specifically, the storage member 10) and the outside (specifically, a gas supply source). The caps 20 and 30 are used to introduce the gas from the container outside into the container inside, and are also used to release the gas from the container inside to the container outside.

The cap 20 is placed on one end side in the axial direction X of the storage member 10. The cap 30 is placed on another end side in the axial direction X of the storage member 10. The caps 20 and 30 are each formed, for example, of a metal such as aluminum or stainless steel for the purpose of ensuring rigidity, etc. The caps 20 and 30 include shaft portions 20a and 30a and flange portions 20b and 30b, respectively.

The shaft portions 20a and 30a are portions that extend in the axial direction X. The shaft portions 20a and 30a are each formed in a tubular shape (e.g., a cylindrical shape) that is fitted to the fitting portion 12 or 13 of the storage member 10. The flange portions 20b and 30b are portions that extend in the radial direction over the entire circumference around the axis. The flange portions 20b and 30b are integrated with the shaft portions 20a and 30a, respectively. The flange portions 20b and 30b are each formed in a disc shape extending outward in the radial direction from the outer surface of the shaft portion 20a or 30a.

The cap 20 has a communication passage 21. The cap 30 has a communication passage 31. The communication passages 21 and 31 are passages that connect the inside of the pressure container 1 (specifically, the storage member 10) to the outside. The communication passage 21 is provided in an axial center portion of the shaft portion 20a. The communication passage 31 is provided in an axial center portion of the shaft portion 30a. The communication passages 21 and 31 extend in the axial direction X, and are each formed, for example, in a circular column shape. The communication passages 21 and 31 are connected to, for example, gas pipes or valves which are not shown, or the like.

In the pressure container 1, the gas may be allowed to enter and exit through both of the communication passages 21 and 31 of the caps 20 and 30, or the gas may be allowed to enter and exit through only one of the communication passages 21 and 31, and a stopper may be attached to the other of the communication passages 21 and 31.

Furthermore, the caps 20 and 30 are formed of a thermally conductive material. The caps 20 and 30 may function as a heat exchanger in which a heat exchange medium circulates in order to adjust the temperature of the pressure container 1. In this case, both of the caps 20 and 30 are suitable to function as heat exchangers, but only any one of the caps 20 and 30 may function as a heat exchanger. For example, if the gas enters and exits through one cap (e.g., the cap 20), another cap (e.g., the cap 30) on the side opposite to that cap may function as a heat exchanger.

The shaft 40 is a shaft member that connects the cap 20 and the cap 30 to each other. The shaft 40 extends straight in the axial direction X. The shaft 40 is connected to the cap 20 at one end portion thereof in the axial direction X, and is connected to the cap 30 at another end portion thereof in the axial direction X. The shaft 40 is inserted and placed in a through hole 11 which is provided in the storage member 10. The shaft 40 is composed of two shaft separate parts 40a and 40b which are separated at the center portion in the axial direction X. The shaft separate parts 40a and 40b are connected to each other at the center portion in the axial direction X, for example, by recess-projection fitting or the like.

The one end portion in the axial direction X of the shaft 40 (specifically, the shaft separate part 40a thereof) is assembled and integrated with the cap 20. In addition, the other end portion in the axial direction X of the shaft 40 (specifically, the shaft separate part 40b thereof) is assembled and integrated with the cap 30. The cap 20, the shaft 40, and the cap 30 are fixed to each other such that relative rotation thereof is restricted, and thus rotate together with each other. The cap 20, the shaft 40, and the cap 30 may be fixed to each other, for example, by press-fitting, bolting, screwing, welding, fusion bonding, or the like.

The shaft 40 is formed of a thermally conductive material. This thermally conductive material is, for example, a material whose thermal conductivity at ordinary temperature (e.g., 25° C.) is higher than the thermal conductivity of air, and specifically a metal, an alloy, ceramics, or the like represented by stainless steel, aluminum, alumina, silicon carbide, etc.

The shaft 40 has a through hole 41 and a vent hole (not shown). The through hole 41 penetrates the storage member 10 between the cap 20 side and the cap 30 side. The through hole 41 is a passage for introducing the gas on the communication passage 21 or 31 side of one of the caps 20 and 30 to the communication passage 31 or 21 side of the other thereof. The above vent hole is a hole that is connected to the through hole 41, extends outward in the radial direction, and is exposed from the outer surface of the shaft 40 to the shaft outside. The vent hole is a passage for introducing the gas, flowing in the through hole 41, from the middle in the axial direction X of the shaft 40 to the storage member 10 on the radially outer side, and also introducing the gas in the storage member 10 through the middle in the axial direction X of the shaft 40 into the through hole 41. A plurality of such vent holes are provided uniformly in the shaft 40.

The storage member 10 and the shaft 40 have a rotation preventing structure in which the storage member 10 and the shaft 40 come into contact with each other to restrict relative rotation thereof. The storage member 10 is placed so as to cover the outer surface of the shaft 40, and the shaft 40 is inserted and placed in the through hole 11 of the storage member 10. One example of this rotation preventing structure is that the outer shape of the shaft 40 and the shape of the through hole 11 of the storage member 10 (i.e., the inner shape of a portion at the periphery of the through hole 11) are noncircular in cross-section (e.g., star-shaped or regular polygonal shape in cross-section, or the like).

The reinforcing layer 50 is a layer that covers the outer circumferential surfaces of the storage member 10 and the caps 20 and 30 to reinforce the storage member 10. Specifically, the reinforcing layer 50 covers the outward-facing surfaces of the body portion and the dome portions of the storage member 10 and the axially outward-facing surfaces of the flange portions 20b and 30b of the caps 20 and 30. The reinforcing layer 50 is composed of, for example, a fibrous member. The reinforcing layer 50 is formed by winding the fibrous member around the outer surface of the storage member 10 by a filament winding (FW) method or the like. The fibrous member forming the reinforcing layer 50 is, for example, a resin-impregnated high-strength fiber (i.e., FRP) such as carbon fibers, glass fibers, and aramid fibers.

The reinforcing layer 50 may be a hoop layer in which the fibrous member is hoop-wound or a helical layer in which the fibrous member is helically wound. In addition, instead of directly winding the fibrous member around the outer surface of the storage member 10, the reinforcing layer 50 may be formed by attaching a helical layer or hoop layer, which is formed in a sheet shape using the fibrous member, to the outer surface of the storage member 10. In addition, the reinforcing layer 50 may be formed with the fibrous member impregnated with a resin, for example, the resin may be thermally cured after the helical layer or the hoop layer is formed. The resin with which the fibrous member is impregnated is a thermosetting resin such as epoxy resins, unsaturated polyester resins, and vinyl ester resins, or the like.

The gas barrier layer 60 is a layer that has gas barrier properties of preventing gas permeation and has heat-shrinkable properties of shrinking by heating. The gas barrier layer 60 is interposed between the outer circumferential surfaces of the storage member 10 and the caps 20 and 30 and the inner circumferential surface of the reinforcing layer 50. The gas barrier layer 60 is a thin member formed in a film shape. The thickness of the gas barrier layer 60 may be any thickness as long as the gas barrier layer 60 has gas barrier properties and heat-shrinkable properties, but may be set to, for example, 0.01 mm to 0.1 mm, and is preferably about 0.1 mm when strength and flexibility are taken into consideration. Also, the temperature at which the gas barrier layer 60 thermally shrinks is, for example, 120°° C. to 140° C., and preferably about 130° C.

The gas barrier layer 60 is formed of a material according to the type of gas to be stored. The material of the gas barrier layer 60 is, for example, an ethylene vinyl alcohol copolymer resin (EVOH), polyvinylidene chloride, or the like. The gas barrier layer 60 covers the outer circumferential surfaces of the storage member 10 and the caps 20 and 30.

The gas barrier layer 60 may be composed of a plurality of separate parts. For example, as shown in FIG. 3, the gas barrier layer 60 may be composed of three gas barrier separate parts 60a, 60b, and 60c. The joints of these three gas barrier separate parts 60a, 60b, and 60c are joined, for example, by fusion bonding.

The gas barrier separate part 60a covers the outer circumferential surface of the body portion of the storage member 10. The gas barrier separate part 60a is composed of, for example, a film member formed in a sheet shape, and is axially wound and placed on the outer circumferential surface of the body portion of the storage member 10 during manufacture of the pressure container 1. The gas barrier separate part 60b covers the outer circumferential surfaces of the cap 20 and the dome portion on the one end side in the axial direction X of the storage member 10. The gas barrier separate part 60b is composed of, for example, a film member formed in a cup shape that matches the outer circumferential surfaces of the cap 20 and the dome portion on the one end side in the axial direction X of the storage member 10, and is placed on the outer peripheral side of the cap 20 and the dome portion on the one end side in the axial direction X of the storage member 10 during manufacture of the pressure container 1. In addition, the gas barrier separate part 60c covers the outer circumferential surfaces of the cap 30 and the dome portion on the other end side in the axial direction X of the storage member 10. The gas barrier separate part 60c is composed of, for example, a film member formed in a cup shape that matches the outer circumferential surfaces of the cap 30 and the dome portion on the other end side in the axial direction X of the storage member 10, and is placed on the outer peripheral side of the cap 30 and the dome portion on the other end side in the axial direction X of the storage member 10 during manufacture of the pressure container 1.

For the gas barrier layer 60, in a state where the cap 30 is placed at the end portion in the axial direction X of the storage member 10, the film-shaped gas barrier separate parts 60a, 60b, and 60c are placed so as to cover the outer circumferential surfaces of the storage member 10 and the caps 20 and 30 as described above, and then are joined by fusion bonding or the like. Then, the gas barrier layer 60 is thermally shrunk by heating to be formed into a shape along the outer circumferential surfaces of the storage member 10 and the caps 20 and 30. The above reinforcing layer 50 is formed so as to cover the outer circumferential surface of the gas barrier layer 60 after the gas barrier layer 60 is thermally shrunk.

Seal members 80 (see FIG. 2 and FIG. 7) are interposed between the cap 20 (specifically, the outer surface of the shaft portion 20a) and the reinforcing layer 50 (precisely, the gas barrier layer 60) and between the cap 30 (specifically, the outer surface of the shaft portion 30a) and the reinforcing layer 50 (precisely, the gas barrier layer 60), respectively. Each seal member 80 is a member for preventing the gas from leaking from the inside of the pressure container 1 to the container outside. Each seal member 80 is, for example, an O-ring formed in an annular shape, or the like. The seal members 80 are mounted so as to be fitted into seal grooves 22 and 32 which are formed on the shaft portions 20a and 30a of the caps 20 and 30 so as to face substantially outward in the radial direction.

The water repellent layer 70 is a layer having water repellency. The water repellent layer 70 has a function of repelling water to prevent water from entering the storage member 10 and the gas barrier layer 60. The water repellent layer 70 is placed outward of the gas barrier layer 60. Specifically, the water repellent layer 70 is placed so as to cover the outer circumferential surface of the reinforcing layer 50. The water repellent layer 70 may be applied to the surface of the reinforcing layer 50 by spraying or the like after the reinforcing layer 50 is formed. The contact angle on the water repellent layer 70 is, for example, in the range of 90° to 180°.

The water repellent layer 70 is formed of a silicon-based or fluorine-based material. In the water repellent layer 70, for example, a crosslinking agent may be added to a fluorine-based resin to enhance the water repellent effect. Alternatively, instead of being placed on the outer peripheral side of the reinforcing layer 50 as described above, the water repellent layer 70 may be applied to the outer surface of the fibrous member, which forms the reinforcing layer 50, during or before the formation of the reinforcing layer 50. Still alternatively, the water repellent layer 70 may be formed by including a water repellent material in the material of the reinforcing layer 50 itself.

Next, an example of a procedure for assembling and manufacturing the pressure container 1 will be described. The assembly and manufacture of the pressure container 1 is performed by a predetermined manufacturing apparatus according to the following procedure.

First, the two storage member separate parts 10a and 10b, which form the storage member 10, are prepared. In addition, the two caps 20 and 30 are prepared, and the two shaft separate parts 40a and 40b, which form the shaft 40, are prepared. Furthermore, the gas barrier separate parts 60a, 60b, and 60c, which form the gas barrier layer 60, are prepared, and the fibrous member, which forms the reinforcing layer 50, is prepared.

Next, the shaft separate part 40a is inserted into the through hole 11 of the storage member separate part 10a, and the shaft separate part 40b is inserted into the through hole 11 of the storage member separate part 10b. In addition, the cap 20 is connected to the shaft separate part 40a and is also placed so as to be fitted to the fitting portion 12 of the storage member separate part 10a, and furthermore, the cap 30 is connected to the shaft separate part 40b and is also placed so as to be fitted to the fitting portion 13 of the storage member separate part 10b (step S100 in FIG. 5). Then, the storage member separate part 10a side and the storage member separate part 10b side are assembled so as to be integrated with each other, and the shaft separate parts 40a and 40b are connected to each other to form a container sub-assembly.

In addition, the seal members 80 are mounted in the seal grooves 22 and 32 of the caps 20 and 30, respectively (step S110). The seal members 80 may be mounted on the caps 20 and 30 after or before the caps 20 and 30 are placed on the storage member 10.

After the above container sub-assembly is formed, first, the gas barrier layer 60 is placed on the outer peripheral side of the storage member 10 and the caps 20 and 30. Specifically, the gas barrier separate part 60a is wound around the outer circumferential surface of the body portion of the storage member 10, and the gas barrier separate parts 60b and 60c are placed on the outer peripheral side of the dome portions of the storage member 10 and the caps 20 and 30. Then, the gas barrier layer 60 is heated, for example, at about 130° C. (step S120). In this case, the gas barrier layer 60 thermally shrinks by the heating to be formed into a shape along the outer circumferential surfaces of the storage member 10 and the caps 20 and 30.

Next, the reinforcing layer 50 is wound and coated on the outer circumferential surface of the gas barrier layer 60, for example, by a filament winding (FW) method. In this case, the reinforcing layer 50 is formed on the outer peripheral side of the gas barrier layer 60 which covers the outer circumferential surfaces of the storage member 10 and the caps 20 and 30 (step S130). Finally, for example, the water repellent layer 70 is applied to the outer circumferential surface of the gas barrier layer 60. In this case, the water repellent layer 70 is formed outward of the gas barrier layer 60 (step S140). The pressure container 1 is manufactured by these processes.

In the manufacturing method for the pressure container 1, in a state where the caps 20 and 30 are placed at the end portions in the axial direction X of the storage member 10, the gas barrier layer 60 having gas barrier properties is placed on the outer peripheral side of the storage member 10 and the caps 20 and 30, and then is thermally shrunk by heating to be formed into a shape along the outer circumferential surfaces of the storage member 10 and the caps 20 and 30. Therefore, according to this manufacturing method, since the gas barrier layer 60 is brought into close contact with the outer circumferential surfaces of the storage member 10 and the caps 20 and 30, the gas barrier properties of the pressure container 1 are sufficiently ensured.

Furthermore, the operation and action of the pressure container 1 will be described.

In the manufactured pressure container 1, for example, when the gas is introduced through the communication passage 21 of the cap 20 in a state where the communication passage 31 of the cap 30 is closed, the gas flows into the through hole 41 of the shaft 40 and then flows into the storage member 10 through the vent hole. The gas having flowed into the storage member 10 is gradually occluded by the storage member 10. Then, after the gas flows thereinto, when the communication passage 21 of the cap 20 is closed, the storage member 10 is filled with the gas.

In addition, after filling the pressure container 1 with the gas, for example, when the communication passage 31 of the cap 30 is opened by the valve, the gas in the storage member 10 is released through the vent hole and the through hole 41 of the shaft 40 and the communication passage 31 to the container outside.

Therefore, in the pressure container 1, the storage member 10 is used to fill the pressure container 1 with the gas, and the filled gas is released to the container outside.

In addition, the pressure container 1 includes the storage member 10 capable of occluding and releasing gas, the caps 20 and 30 placed at the end portions in the axial direction X of the storage member 10, the reinforcing layer 50 covering the outer circumferential surfaces of the storage member 10 and the caps 20 and 30, and the gas barrier layer 60 interposed between the outer circumferential surfaces of the storage member 10 and the caps 20 and 30 and the inner circumferential surface of the reinforcing layer 50, formed in a film shape, and having gas barrier properties and heat-shrinkable properties.

In the configuration of the pressure container 1, the storage member 10 is used to fill the pressure container 1 with the gas without a liner, thereby achieving cost reduction and weight reduction while efficiently filling the pressure container 1 with the gas. In addition, gas barrier properties are ensured by the gas barrier layer 60, and the gas barrier layer 60 is brought into close contact with the outer circumferential surfaces of the storage member 10 and the caps 20 and 30 by heating, so that the gas barrier properties are sufficiently ensured. Therefore, the pressure container 1 sufficiently ensures gas barrier properties while achieving efficient gas filling without a liner.

The pressure container 1 also includes the water repellent layer 70 placed outward of the gas barrier layer 60. In the configuration of the pressure container 1, the water repellent layer 70 repels water to prevent water from entering the gas barrier layer 60, thereby improving the water resistance of the pressure container 1 and increasing the strength of the pressure container 1 in use.

The present invention is not limited to the above-described embodiment and modifications, and various changes may be made without departing from the gist of the present invention. In addition, the present specification discloses not only the technical concept indicated by the citation relationship between the claims as originally filed, but also the technical concept obtained by combining the matters recited in each claim as appropriate.

This application claims priority on Japanese Patent Application No. 2023-046084 filed on Mar. 22, 2023, the entire contents of which are incorporated herein by reference.

1. A pressure container comprising:
a storage member extending in an axial direction and capable of occluding and releasing gas;
a cap placed at an end portion in the axial direction of the storage member;
a reinforcing layer covering outer circumferential surfaces of the storage member and the cap; and
a gas barrier layer interposed between the outer circumferential surfaces and an inner circumferential surface of the reinforcing layer, formed in a film shape, and having gas barrier properties and heat-shrinkable properties.

2. The pressure container according to claim 1, further comprising a water repellent layer placed outward of the gas barrier layer.

3. A method for manufacturing the pressure container according to claim 1, the method comprising:
a first step of thermally shrinking the gas barrier layer, which is placed on an outer peripheral side of the storage member and the cap in a state where the cap is placed at the end portion in the axial direction of the storage member, by heating to form the gas barrier layer into a shape along the outer circumferential surfaces; and
a second step of forming the reinforcing layer on the outer peripheral side of the gas barrier layer.
